(19) United States
(12) Patent Application Publication
(10) Pub. No.: US 2012/0229487 A1
(43) Pub. Date: Sep. 13, 2012

(54) Method and Apparatus for Reflection Compensation

(75) Inventors: Vidyut SAMANTA, Los Angeles, CA (US); Lance WILLIAMS, Toluca Lake, CA (US); Ronald AZUMA, Santa Monica, CA (US)

(73) Assignee: NOKIA CORPORATION, Espoo (FI)

(21) Appl. No.: 13/045,938

(22) Filed: Mar. 11, 2011

(51) Int. Cl. G09G 5/00

(52) U.S. Cl. 345/582; 345/581

(57) ABSTRACT

A method comprising determining that light reflected by a display obstructs view of the display, and causing compensation for reflected light based on the determination that light reflected by a display obstructs view of the display is disclosed.

### TECHNICAL FIELD

The present application relates generally to display compensation.

### BACKGROUND

Electronic devices are becoming ubiquitous in the lives of many people. Many electronic devices provide information to a user by way of a display. Under some circumstances, light reflecting from a display may obstruct a user from adequately perceiving the information provided by the device.

### SUMMARY

Various aspects of examples of the invention are set out in the claims.

An apparatus, comprising a processor, memory including computer program code, the memory and the computer program code configured to, working with the processor, cause the apparatus to perform at least determining that light reflected by a display obstructs view of the display, and causing compensation for reflected light based on the determination that light reflected by a display obstructs view of the display is disclosed.

A method comprising determining that light reflected by a display obstructs view of the display, and causing compensation for reflected light based on the determination that light reflected by a display obstructs view of the display is disclosed.

A computer-readable medium encoded with instructions that, when executed by a computer, perform determining that light reflected by a display obstructs view of the display, and causing compensation for reflected light based on the determination that light reflected by a display obstructs view of the display is disclosed.

### BRIEF DESCRIPTION OF THE DRAWINGS

For a more complete understanding of embodiments of the invention, reference is now made to the following descriptions taken in connection with the accompanying drawings in which:

FIGS. 1A-1F are diagrams illustrating reflection compensation according to at least one example embodiment;

FIGS. 2A-2J are diagrams illustrating reflected light according to at least one example embodiment;

FIGS. 3A-3C are diagrams illustrating at least one camera according to at least one example embodiment;

FIG. 4 is a flow diagram showing a set of operations for reflection compensation according to an example embodiment;

FIG. 5 is a flow diagram showing a set of operations for reflection compensation according to an example embodiment; and

FIG. 6 is a block diagram showing an apparatus according to an example embodiment.

### DETAILED DESCRIPTION OF THE DRAWINGS

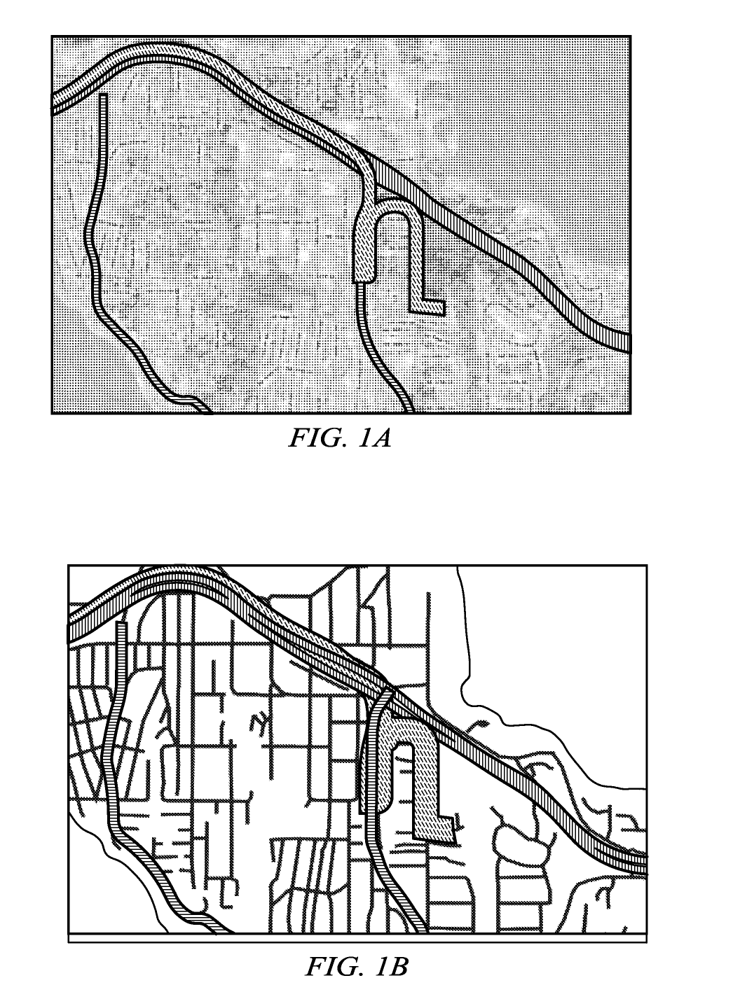

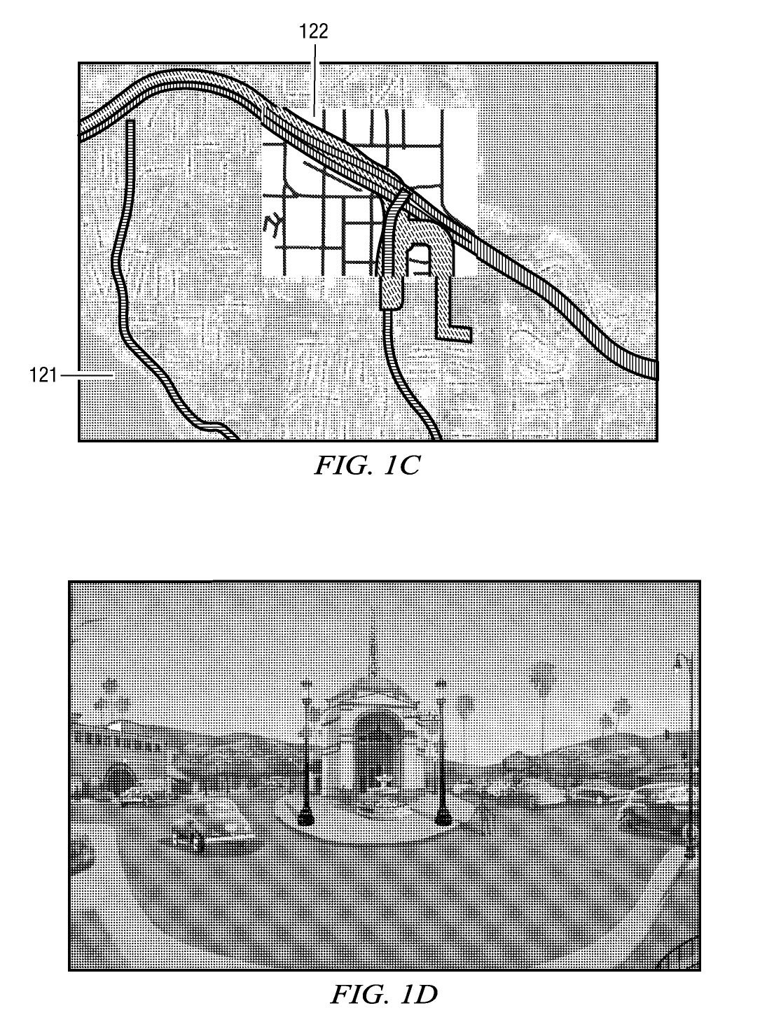

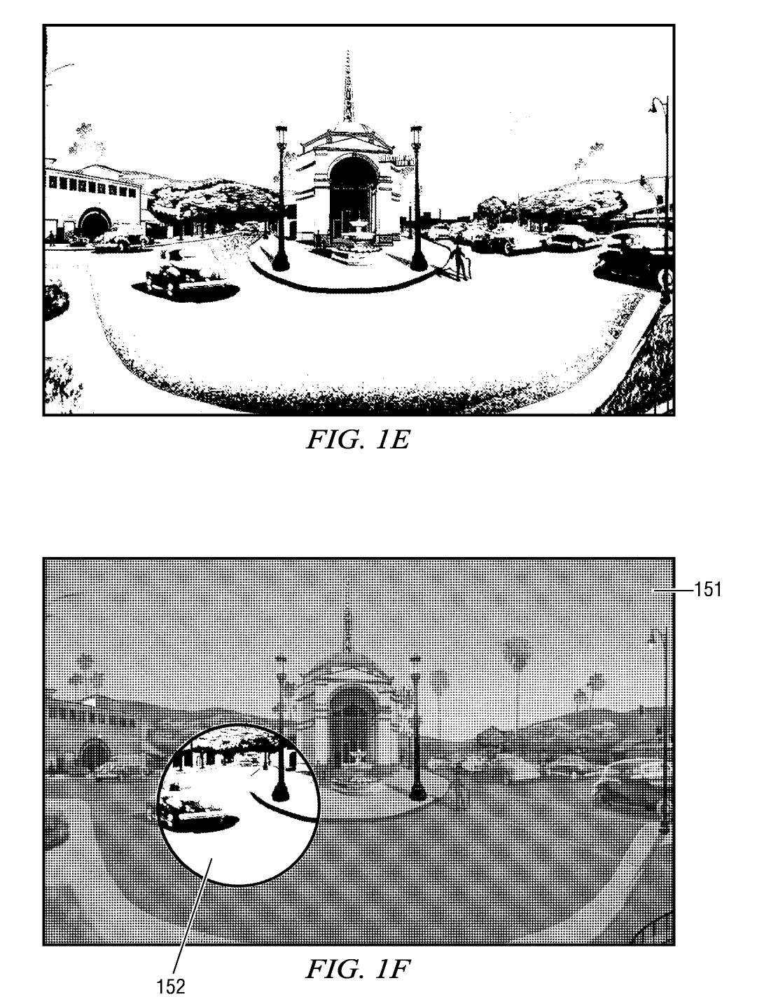

An embodiment of the invention and its potential advantages are understood by referring to FIGS. 1 through 6 of the drawings.

Many electronic devices comprise a display upon which information may be displayed for a user to view. Under some circumstances, light reflected by the display may obstruct view of the display. For example, the user may experience a glare that interferes with perception of information displayed by the display. In another example, light reflected from the display may fail to generate a glare, but may reduce contrast of displayed information. Under such circumstances, the user may have difficulty perceiving the information displayed by the display. In an example embodiment, an apparatus may detect that light reflected by a display obstructs view of the display, and cause compensation for the reflected light. Without limiting the scope of the claims in any way, at least one technical effect of such determination and compensation is to reduce interference of light reflection upon user perception of displayed information.

FIGS. 1A-1F are diagrams illustrating reflection compensation according to at least one example embodiment. The examples of FIGS. 1A-1F are merely examples of reflection compensation, and do not limit the scope of the claims. For example, the manner in which compensation is performed may vary, the degree of compensation may vary, and/or the like.

In an example embodiment, compensation for reflected light comprises performing an action that improves perception of displayed information. Compensation may relate to a characteristic of the display, a characteristic of the information displayed, and/or the like. Compensation may relate to the entirety of the display, a part of the display that is less than the entirety of the display, and/or the like. Compensation may relate to the entirety of information displayed, a part of the information displayed that is less than the entirety of information displayed, and/or the like.

In an example embodiment, compensation for reflected light comprises varying at least one reflective property of the display. For example, varying the reflective property may comprise varying polarity of at least part of the display. In such an example, a display may comprise a variable polarity display. The polarity of the display may be varied in response to determination that reflected light obstructs view of the display, such that the polarity of the display reduces obstruction caused by the reflected light. In such an example, polarity of the display may be modified by rotating polarization with a magnetic field based upon Faraday rotation. In another example, varying the reflective property comprises varying texture of at least part of the display. In such an example, the display may comprise a switchable lotus-leaf texture, a switchable antireflective nanostructure, and/or the like, such that reflectivity of the surface of the display may be varied. For example, surface of the display may be varied to be less reflective. In another example, surface of the display may be adjusted to reflect at a variable angle. In such an example, the apparatus may comprise an adjustable liquid crustal blazed grating deflector

In an example embodiment, compensation for reflected light comprises compensating information that is caused to be displayed on the display. For example, information that is caused to be displayed may be compensated such that the information is more perceptible under unfavorable conditions. In such an example, information may be compensated such that the compensated information resembles information suitable for perception by a visually impaired viewer. Such suitability may relate to exaggerated lightness differences between foreground and background, having colors that are adjacent to each other be distant from each other on the color wheel, thicker lines, a small color palate comprised of colors having disparate hues, and/or the like.

In an example embodiment, compensating information that is caused to be displayed on the display comprises utilizing a predetermined compensated set of information and causing display of at least part of the predetermined compensated set of information on the display. A predetermined compensated set of information may relate to an alternate set of information that is has been previously generated such that obstruction is compensated. For example, an image to be displayed may have an associated compensated image. In such an example, compensating the image may comprise utilizing, at least part of, the compensated image. In such an example, the compensated image may have been generated by an artist, generated by a program, and/or the like. In such an example, an apparatus may receive the image along with the related compensated image. In an example embodiment, an apparatus may cause display of the entirety of the predetermined compensated set of information, a part of the predetermined set of compensated information that is less than the entirety of the compensated set of information, and/or the like. In an example embodiment, the at least part of the compensated set of information may be caused to be displayed in conjunction with at least part of the information, such as an overlay, a partial replacement, and/or the like. In another example embodiment, the compensated set of information may be caused to be displayed instead of the information.

In an example embodiment, compensating information comprises causing compensation generation of the information that is caused to be displayed. Compensation generation of the information comprises generating the information such that the resulting information is compensated. For example, a program may generate uncompensated information under unobstructed circumstances and generate compensated information under obstructed circumstances. In such an example, the generated uncompensated information may have adjacent colors that have similar hue. In the same example, the generated compensated information may preclude adjacent colors from having similar hue. In another example, the apparatus may pass an image though one or more filters that modify the image to make it read better in poor lighting conditions. In such an example, the filter may find an edge and bold outline of the edge. In such an example, a filter could change the color palette, or manipulate brightness, exposure, contrast, hue, or saturation. In such an example, a filter may perform text recognition and change the font, or font size to improve readability. In yet another example, the apparatus may modify an image so that the modified image exaggerates areas of the image that are obstructed.

FIG. 1A is a diagram illustrating an example of information that may be caused to be displayed on a display. In the example of FIG. 1A, the information is an image of a map. The image may contain many hues, fine contrast variation, small details, and/or the like. At least one of these attributes of the image may be difficult to perceive when light reflected from a display obstructs view of the display on which the information is caused to be displayed.

FIG. 1B is a diagram illustrating an example of compensated information. The compensated information of FIG. 1B may have been generated in lieu of generating information of FIG. 1A. The compensated information of FIG. 1B may be a predetermined compensated set of information associated with the information of FIG. 1A. The information of FIG. 1B may lack the many hues, fine contrast variation, small details, and/or the like, that may be present in the information of FIG. 1A.

FIG. 1C is a diagram illustrating information, wherein a part, that is less than the entirety, of the information has been compensated. Information 121 indicates uncompensated information. Information 122 indicates compensated information. Information 121 is similar to the information of FIG. 1A. Information 122 is similar to the information of FIG. 1B. Information 122 may be, at least part of, a predetermined compensated set of information associated with the information of FIG. 1A. Information 122 may have been generated in lieu of generating the corresponding part of information 121. Information 121 may comprise the many hues, fine contrast variation, small details, and/or the like, that may be present in the information of FIG. 1A. Information 122 may lack the many hues, fine contrast variation, small details, and/or the like, that may be present in the information of FIG. 1A. In an example embodiment, information 122 may vary by size, shape, orientation, content, and/or the like.

FIG. 1D is a diagram illustrating an example of information that may be caused to be displayed on a display. In the example of FIG. 1D, the information is an image photograph. The image may contain many hues, fine contrast variation, small details, and/or the like. At least one of these attributes of the image may be difficult to perceive when light reflected from a display obstructs view of the display on which the information is caused to be displayed.

FIG. 1E is a diagram illustrating an example of compensated information. The compensated information of FIG. 1E may have been generated in lieu of generating information of FIG. 1D. The compensated information of FIG. 1E may be a predetermined compensated set of information associated with the information of FIG. 1D. The information of FIG. 1E may lack the many hues, fine contrast variation, small details, and/or the like, that may be present in the information of FIG. 1D.

FIG. 1F is a diagram illustrating information, wherein a part, that is less than the entirety, of the information has been compensated. Information 151 indicates uncompensated information. Information 152 indicates compensated information. Information 151 is similar to the information of FIG. 1D. Information 152 is similar to the information of FIG. 1E. Information 152 may be, at least part of, a predetermined compensated set of information associated with the information of FIG. 1D. Information 152 may have been generated in lieu of generating the corresponding part of information 151. Information 151 may comprise the many hues, fine contrast variation, small details, and/or the like, that may be present in the information of FIG. 1D. Information 152 may lack the many hues, fine contrast variation, small details, and/or the like, that may be present in the information of FIG. 1D. In an example embodiment, information 152 may vary by size, shape, orientation, content, and/or the like.

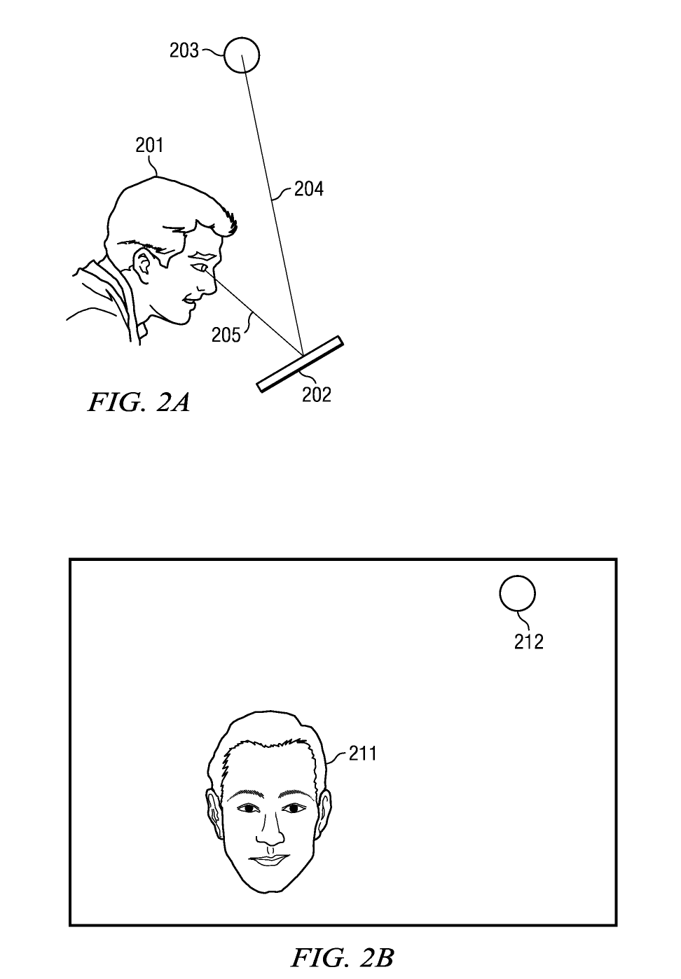

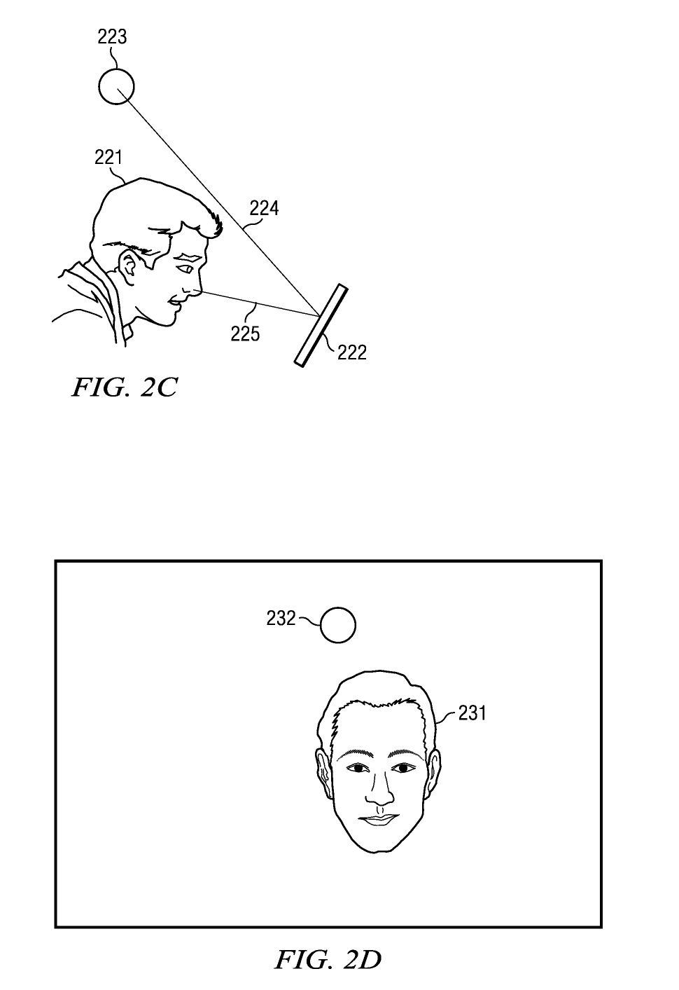

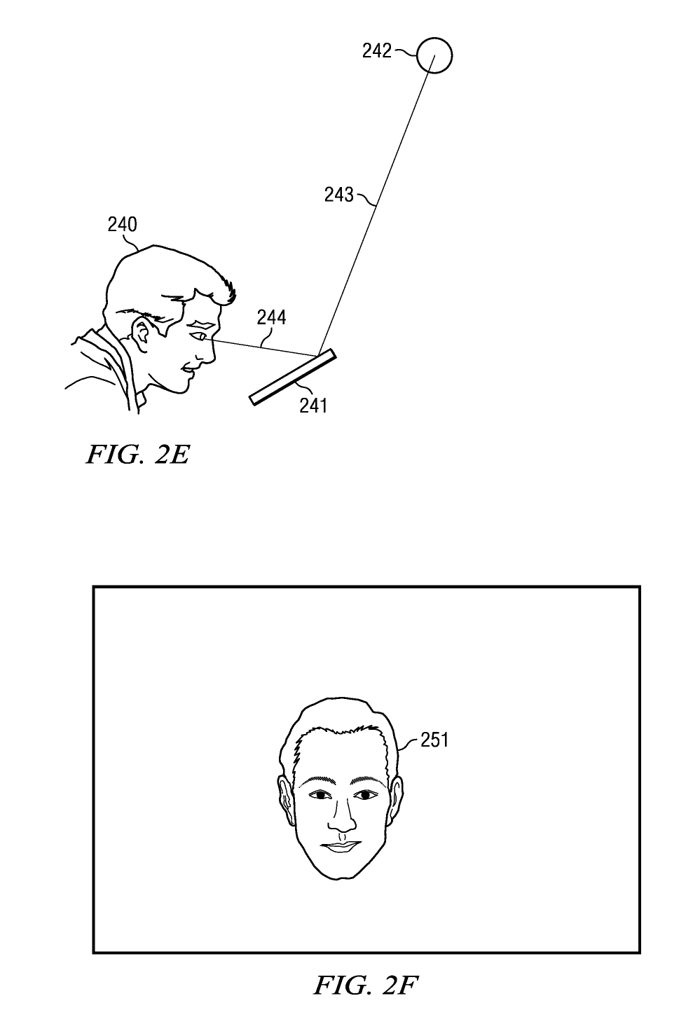

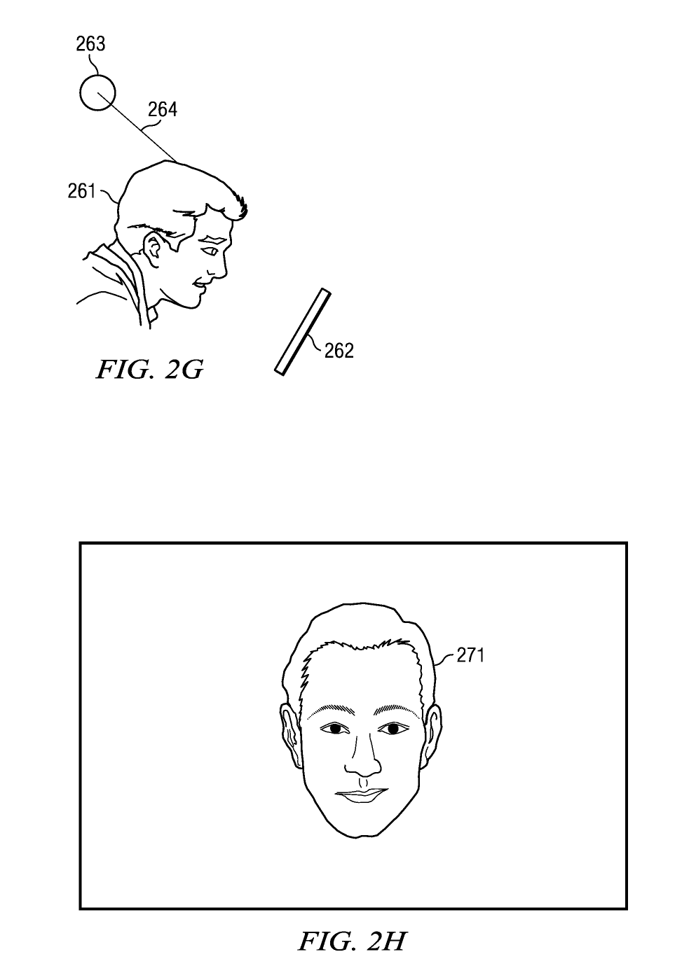

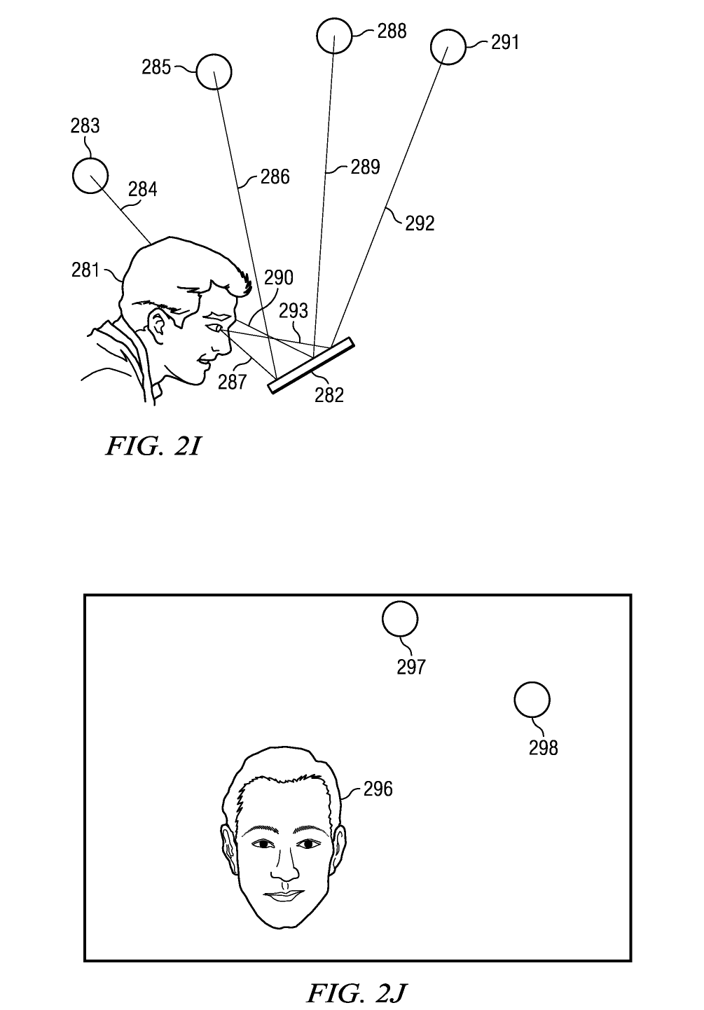

FIGS. 2A-2J are diagrams illustrating reflected light according to at least one example embodiment. The examples of FIGS. 2A-2J are merely examples of reflected light, and do not limit the scope of the claims. For example, light sources may vary by number, size, orientation, location, and/or the like. Furthermore, even though the examples of FIGS. 2A-2J indicate two-dimensional relationships, similar principals apply to three-dimensional relationships. For example, angles, positions, vectors, and/or the like may be three-dimensional.

In an example embodiment, an apparatus determines that light reflected by a display obstructs view of, at least part of, the display. The apparatus may utilize information relating to a light source, a user, the display, and/or the like.

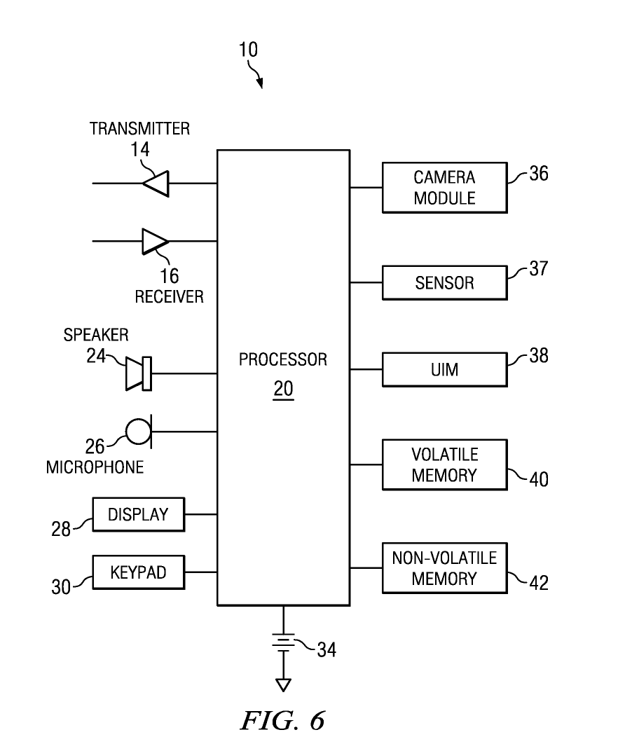

In an example embodiment, in determining that light reflected by a display obstructs view of, at least part of, the display, an apparatus determines information relating to a light source. The information relating to the light source may comprise information indicating position of the light source, intensity of the light source, orientation of the light source, and/or the like. The light source information may be based on a geographic reference, such as longitude and latitude, may be based on the display, such as position and/or orientation with respect to the display, and/or the like. The apparatus may determine the information pertaining to the light source using sensor information to perceive the light source. For example, the apparatus may utilize a camera, a light sensor, and/or the like. In another example, the apparatus may utilize stored information indicating position of the light source, orientation of the light source, and/or the like. In such an example, the apparatus may retrieve light source information. Under such circumstances, the apparatus may retrieve information from a repository. The repository may be internal to the apparatus, such as in non-volatile memory 40 of FIG. 6. The repository may be external to the apparatus, such as a server, database, and/or the like. Retrieval of light source information may be based, at least in part, on information relating to the display. For example, the apparatus may request light source information associated with a position, such as position of the display. In an example embodiment, the light source is the sun. The apparatus may determine position of the sun by utilizing astronomical information and display information, such as position and orientation of the display, to determine whether light reflected from the sun may obstruct view of the display. In another example embodiment, the light source is a light fixture in a building. In such an example, the repository may comprise position and orientation information for the light fixture.

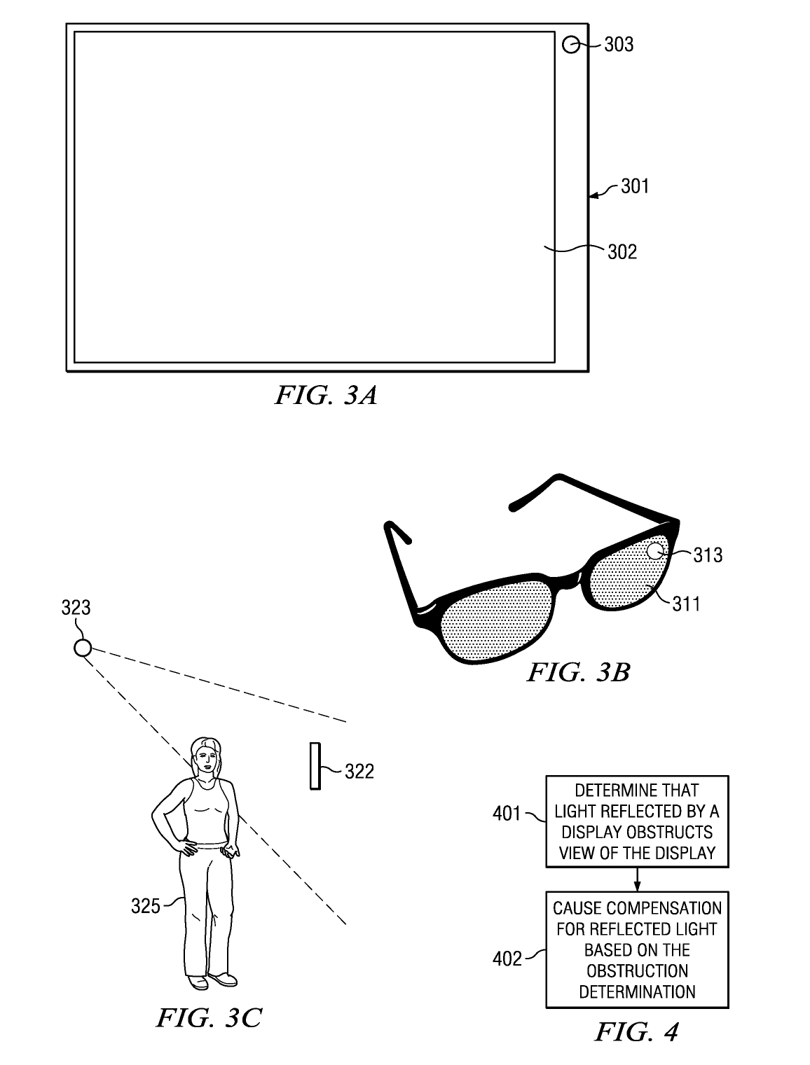

In an example embodiment, an apparatus determines light source information based on an image indicating the light source. The image may be captured by a camera, similar as described with reference to FIGS. 3A-3C. The light source information may be based, at least in part, on the image of the light source. For example, the apparatus may determine position of the light source relative to the display based, at least in part, on position of the light source in the image. The apparatus may utilize information regarding camera position, orientation, and/or the like to determine the light source information. For example, a camera adjacent to the display may provide a basis to determine the angle of the light source in the field of view of the camera, relative to the display. The apparatus may determine position of the light source from this angle. In another example, the apparatus may determine position of the display provided by a positioning sensor and the orientation of the display that may be determined based on an inclination sensor and/or digital compass. In an example embodiment, the image may comprise indication of at least one marker. The apparatus may utilize the marker to determine the light source information. For example, the marker may indicate position of the light source, identification of the light source, orientation of the light source, and/or the like.

In an example embodiment, an apparatus monitors relative movement between the display and the light source. For example, the apparatus may determine position of the light source, and monitor movement of the display. In such an example, the apparatus may base further light source information, at least in part, on the previously determined light source information and the monitored movement of the display. For example, a user may be holding a display while walking through a building. The apparatus may determine position and orientation of a light source with respect to the display. As the user moves to a different position, the apparatus may determine a different position and orientation of the light source based on the previously determined light source information and the monitored movement of the display.

In an example embodiment, the apparatus utilizes historical light source information. Historical light source information relates to light source information previously determined by the apparatus. Under some circumstances, the apparatus may presume light source information based on a previous display location and/or orientation. For example, the apparatus may utilize historic light source information for a stationary display. In another example, the apparatus may utilize historic light source information based on determination that the apparatus has previously determined light source information for similar display position and/or orientation information, and that previous light source determinations were consistent with each other. Under some circumstances, the apparatus may be able to determine light source information using historical light source information more quickly than using a different type of light source determination.

In an example embodiment, in determining that light reflected by a display obstructs view of, at least part of, the display, an apparatus may determine information relating to the display. The information relating to the display may comprise information indicating position of the display, orientation of the display, and/or the like. The apparatus may determine position of the display based on assisted position determination, such as a global positioning system, based on stored position value, based on received information from a separate apparatus indicating position of the display, and/or the like. The apparatus may determine orientation based, at least in part on one or more sensors, such as sensor 37 of FIG. 6. For example, the apparatus may use an accelerometer, a gyroscope, and/or the like.

In an example embodiment, in determining that light reflected by a display obstructs view of, at least part of, the display, an apparatus may determine information relating to a viewer of the display. A viewer of the display relates to an entity that is viewing the display, such as a person, a camera, and/or the like. The information relating to the viewer may comprise information indicating position of the viewer, orientation of the viewer, attention of the viewer, and/or the like. In an example embodiment, the apparatus may utilize an image indicating the viewer to determine information relating to the viewer. The image may be captured by a camera, similar as described with reference to FIGS. 3A-3C. The apparatus may use face tracking or eye tracking to determine information relating to the viewer. The apparatus may use markers indicating the viewer to determine information relating to the viewer. The apparatus may recognize eyes of a person and utilize position and/or orientation of the eyes to determine information relating to the viewer.

In an example embodiment, an apparatus determines that light reflected by a display does not obstruct view of, at least part of, the display. The apparatus may utilize information relating to a light source, a user, the display, and/or the like. For example, the apparatus may determine that a viewer of the display has terminated viewing of the display. In another example, the apparatus may determine that a light source has become obstructed. In still another example, the apparatus may determine that there is no light source bright enough to be obstructing.

FIG. 2A is a diagram illustrating a viewer 201 of display 202 in relation to a light source 203, according to an example embodiment. In the example of FIG. 2A, incident light 204 from the light source reflects from display 202 and yields reflected light 204. In the example of FIG. 2A, reflected light 205 enters the eye of viewer 201. Under such circumstances, an apparatus may determine to perform compensation of at least part of information caused to be displayed by display 202. In an example embodiment, an apparatus detecting the circumstances illustrated by FIG. 2A causes compensation for reflected light 205.

In an example embodiment, an apparatus may determine position of light source 203 in relation to display 202. The apparatus may determine that the display is oriented such that the information caused to be displayed by the display will be obstructed by the reflected light entering the viewer's eye. The apparatus may cause compensation for reflected light 205 based, at least in part, on this determination.

FIG. 2B is a diagram illustrating an image comprising viewer indication 211 and light source indication 212, according to an example embodiment. The image of FIG. 2B may relate to the circumstances described with regard to FIG. 2A. Viewer indication 211 may correspond to viewer 201 of FIG. 2B. Light source indication 212 may correspond to light source 202 of FIG. 2A. In an example embodiment, an apparatus utilizes the image of FIG. 2B to determine whether light reflected by a display obstructs view of the display. For example, the apparatus may utilize information pertaining to the camera that captured the image in relation to the display to evaluate light source indication 212 in relation to viewer indication 211. The apparatus may further determine a region of the display that is obscured by light reflected by the light source associated with light source indication 212, and confine compensation to that region.

FIG. 2C is a diagram illustrating a viewer 221 of display 222 in relation to a light source 223, according to an example embodiment. In the example of FIG. 2C, incident light 224 from the light source reflects from display 222 and yields reflected light 224. In the example of FIG. 2C, reflected light 225 fails to enter the eye of viewer 221. Under such circumstances, an apparatus may determine to abstain from performing compensation of at least part of information caused to be displayed by display 222. In an example embodiment, an apparatus detecting the circumstances illustrated by FIG. 2C abstains from causing compensation for reflected light 225.

In an example embodiment, an apparatus may determine position of light source 223 in relation to display 222. The apparatus may determine that the display is oriented such that the information caused to be displayed by the display will not be obstructed by the reflected light entering the viewer's eye. The apparatus may cause abstinence of compensation for reflected light 225 based, at least in part, on this determination. For example, if the apparatus had been previously compensating for reflected light, the apparatus may terminate compensation.

FIG. 2D is a diagram illustrating an image comprising viewer indication 231 and light source indication 232, according to an example embodiment. The image of FIG. 2D may relate to the circumstances described with regard to FIG. 2C. Viewer indication 231 may correspond to viewer 221 of FIG. 2D. Light source indication 232 may correspond to light source 222 of FIG. 2C. In an example embodiment, an apparatus utilizes the image of FIG. 2D to determine whether light reflected by a display fails to obstruct view of the display. For example, the apparatus may utilize information pertaining to the camera that captured the image in relation to the display to evaluate light source indication 232 in relation to viewer indication 231.

FIG. 2E is a diagram illustrating a viewer 240 of display 241 in relation to a light source 242, according to an example embodiment. In the example of FIG. 2E, incident light 243 from the light source reflects from display 241 and yields reflected light 204. In the example of FIG. 2E, reflected light 244 enters the eye of viewer 240. Under such circumstances, an apparatus may determine to perform compensation of at least part of information caused to be displayed by display 241. In an example embodiment, an apparatus detecting the circumstances illustrated by FIG. 2E causes compensation for reflected light 244.

In an example embodiment, an apparatus determines position of light source 242 in relation to display 241. The apparatus may determine that the display is oriented such that the information caused to be displayed by the display will be obstructed by the reflected light entering the viewer's eye. The apparatus may cause compensation for reflected light 244 based, at least in part, on this determination.

FIG. 2F is a diagram illustrating an image comprising viewer indication 251, according to an example embodiment. The image of FIG. 2F may relate to the circumstances described with regard to FIG. 2E. Viewer indication 251 may correspond to viewer 240 of FIG. 2E. In the example of FIG. 2F, the image is absent indication of a light source. In an example embodiment, an apparatus utilizes the image of FIG. 2F to determine viewer position and orientation with respect to the camera. For example, the apparatus may utilize information pertaining to the camera that captured the image in relation to the display to determine viewer information associated with the viewer indicated by viewer indication 251. The apparatus may determine light source information without regard to the image. For example, the apparatus may utilize a repository, historical information, and/or the like. The apparatus may further determine reflected light based on the determined light source information, display position and orientation, and the determined viewer information.

FIG. 2G is a diagram illustrating a viewer 261 of display 262 in relation to a light source 263, according to an example embodiment. In the example of FIG. 2G, incident light 264 from the light source fails to reflect from display 222 in a way that obstructs viewer 261. Under such circumstances, an apparatus may determine to abstain from performing compensation of at least part of information caused to be displayed by display 262. In an example embodiment, an apparatus detecting the circumstances illustrated by FIG. 2G abstains from causing compensation for reflected light.

In an example embodiment, an apparatus may determine position of light source 263 in relation to display 262. The apparatus may determine that the display is oriented such that the information caused to be displayed by the display will not be obstructed by the reflected light entering the viewer's eye. The apparatus may cause abstinence of compensation for reflected light based, at least in part, on this determination. For example, if the apparatus had been previously compensating for reflected light, the apparatus may terminate compensation.

FIG. 2H is a diagram illustrating an image comprising viewer indication 271, according to an example embodiment. The image of FIG. 2H may relate to the circumstances described with regard to FIG. 2G. Viewer indication 271 may correspond to viewer 261 of FIG. 2G. In the example of FIG. 2H, the image is absent indication of a light source. In an example embodiment, an apparatus utilizes the image of FIG. 2F to determine viewer position and orientation with respect to the camera. For example, the apparatus may utilize information pertaining to the camera that captured the image in relation to the display to determine viewer information associated with the viewer indicated by viewer indication 271.

The apparatus may determine light source information without regard to the image. For example, the apparatus may utilize a repository, historical information, and/or the like. The apparatus may further determine absence of obstruction from reflected light based on the determined light source information, display position and orientation, and the determined viewer information.

The apparatus may determine absence of obstruction without determining light source information beyond the image. For example, the apparatus may presume that lack of light source indication in the image indicates absence of obstruction from reflection.

FIG. 2I is a diagram illustrating a viewer 281 of display 282 in relation to a light sources 283, 285, 288, and 291, according to an example embodiment. In the example of FIG. 2I, incident light 284 from light source 283 fails to reflect from display 282 in a way that obstructs viewer 281, incident light 286 from light source 285 reflects from display 282 and yields reflected light 287, incident light 289 from light source 288 reflects from display 282 and yields reflected light 290, incident light 292 from light source 291 reflects from display 282 and yields reflected light 293. In the example of FIG. 2A, reflected light 287 and reflected light 293 enter the eye of viewer 281. Under such circumstances, an apparatus may determine to perform compensation of at least part of information caused to be displayed by display 282. In an example embodiment, an apparatus detecting the circumstances illustrated by FIG. 2I causes compensation for reflected light 287 and/or reflected light 293.

In an example embodiment, an apparatus may determine position of light sources 283, 285, 288, and 291 in relation to display 282. The apparatus may determine that the display is oriented such that the information caused to be displayed by the display will be obstructed by the reflected light entering the viewer's eye. The apparatus may cause compensation for reflected light 287 and/or reflected light 293 based, at least in part, on this determination.

FIG. 2J is a diagram illustrating an image comprising viewer indication 296, light source indication 297, and light source indication 298, according to an example embodiment. The image of FIG. 2J relates to the circumstances described with regard to FIG. 2I. Viewer indication 296 corresponds to viewer 281 of FIG. 2J. Light source indication 297 corresponds to light source 288 of FIG. 2I. Light source indication 298 corresponds to light source 285 of FIG. 2I. In an example embodiment, an apparatus utilizes the image of FIG. 2J to determine whether light reflected by a display obstructs view of the display. For example, the apparatus may utilize information pertaining to the camera that captured the image in relation to the display to evaluate light source indications 297 and 298 in relation to viewer indication 296. The apparatus may further determine a region of the display that is obscured by light reflected by the light source associated with light source indication 298, and confine compensation to that region.

In an example embodiment, an apparatus performs compensation for reflected light based on the image without regard for other light source information. For example, the apparatus may omit determining light source information associated with light sources 283 and 291 of FIG. 2I. Under such circumstances, where the apparatus performs compensation of a region of information, the apparatus may fail to perform compensation of a region associated with reflected light 293, but perform compensation of a region associated with reflected light 287.

In an example embodiment, the apparatus determines light source information based on the image and based on additional light source information beyond the image. For example, the apparatus may utilize a repository, historical information, and/or the like, to determine light source information associated with light source 291. The apparatus may further determine reflected light based on the determined light source information, display position and orientation, and the determined viewer information.

FIGS. 3A-3C are diagrams illustrating at least one camera according to at least one example embodiment. The examples of FIGS. 3A-3C are merely examples of a camera, and do not limit the scope of the claims. For example, cameras may vary by number, position, size, orientation, and/or the like. For example, multiple cameras may be utilized to reduce errors, provide for three dimensional imaging, and/or the like.

FIG. 3A is a diagram illustrating a device that comprises a display 302 and a camera 303, according to an example embodiment. Device 301 may be the apparatus that performs the operations 400 of FIG. 4, or separate from the apparatus that performs the operations 400 of FIG. 4. Camera 303 may capture images similar to the images of FIGS. 2B, 2D, 2F, 2H, and 2J. The apparatus may utilize an image from camera 303 to determine light source information, viewer information, and/or the like, in relation to the display.

FIG. 3B is a diagram illustrating a wearable device 311 that comprises a camera 313. Device 301 may be the apparatus that performs the operations 400 of FIG. 4, or separate from the apparatus that performs the operations 400 of FIG. 4. The apparatus may utilize an image from camera 313 to determine reflection information, display information in relation to the viewer, and/or the like.

FIG. 3C is a diagram illustrating a camera 323 operates separably from viewer 325 and display 322. Camera 323 may be part of the apparatus that performs the operations 400 of FIG. 4, or separate from the apparatus that performs the operations 400 of FIG. 4. The apparatus may utilize an image from camera 313 to determine reflection information, display information in relation to the viewer, viewer information, and/or the like.

FIG. 4 is a flow diagram showing a set of operations 400 for reflection compensation according to an example embodiment. An apparatus, for example electronic device 10 of FIG. 6 or a portion thereof, may utilize the set of operations 400. The apparatus may comprise means, including, for example processor 20 of FIG. 6, for performing the operations of FIG. 4. In an example embodiment, an apparatus, for example device 10 of FIG. 6, is transformed by having memory, for example memory 42 of FIG. 6, comprising computer code configured to, working with a processor, for example processor 20 of FIG. 6, cause the apparatus to perform set of operations 400.

At block 401, the apparatus determines that light reflected by a display obstructs view of, at least part of, the display. The determination may be similar as described with reference to FIGS. 2A-2J, FIGS. 3A-3C, and/or the like.

At block 402, the apparatus causes compensation for reflected light based, at least in part, on the determination that light reflected by a display obstructs view of, at least part of, the display. The compensation may be similar as described with reference to FIGS. 1A-1F. The compensation may be performed in response to the determination of block 401.

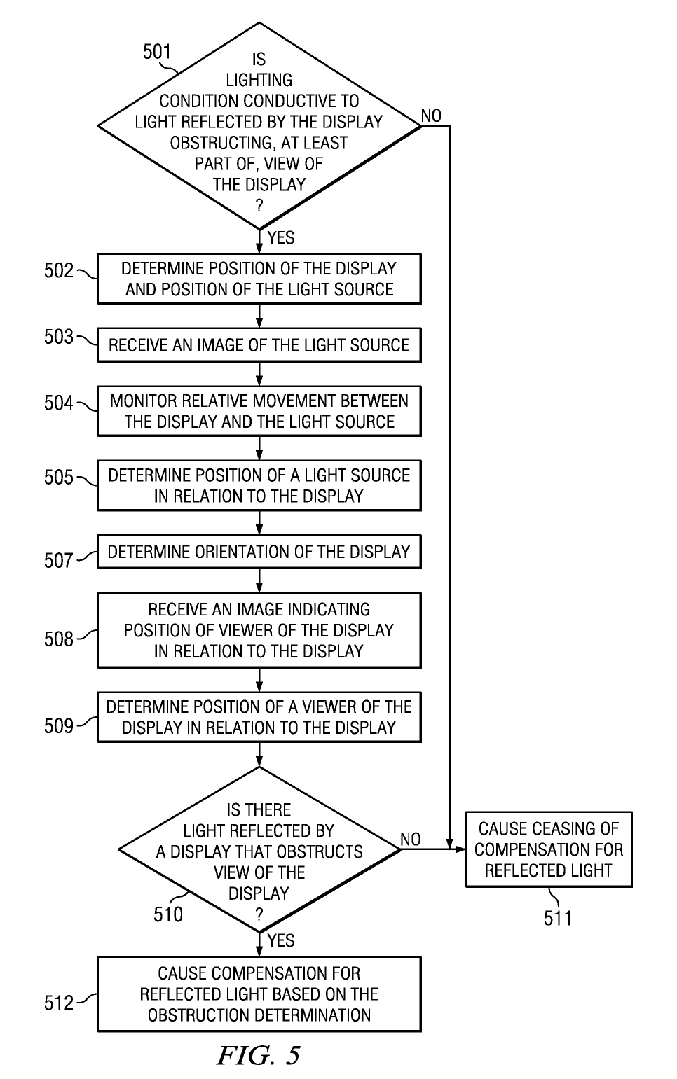

FIG. 5 is a flow diagram showing a set of operations 500 for reflection compensation according to an example embodiment. An apparatus, for example electronic device 10 of FIG. 6 or a portion thereof, may utilize the set of operations 500. The apparatus may comprise means, including, for example processor 20 of FIG. 6, for performing the operations of FIG. 5. In an example embodiment, an apparatus, for example device 10 of FIG. 6, is transformed by having memory, for example memory 42 of FIG. 6, comprising computer code configured to, working with a processor, for example processor 20 of FIG. 6, cause the apparatus to perform set of operations 500.

At block 501, the apparatus determines whether a lighting condition is conducive to light reflected by the display obstructing, at least part of, view of the display. Determination that a lighting condition is conducive to obstruction may relate to a light sensor determining a level of light beyond a threshold, determination that the display is outdoors, determining that the weather condition is conducive to high sunlight, and/or the like. If, at block 501, the apparatus determines that the lighting condition is not conducive to light reflected by the display obstructing, at least part of, view of the display, flow proceeds to block 511. Otherwise, flow proceeds to block 502.

At block 502, the apparatus determines, at least one of position or orientation, of the display and determines, at least one of position or orientation, of the light source. Determination of position and/or orientation of the display and light source may be similar as described with reference to FIGS. 2A-2J.

At block 503, the apparatus receives an image indicating the light source. The apparatus may receive the image from a camera similar as described with reference to FIGS. 3A-3C. The image may be similar as described with reference to FIGS. 2A-2J.

At block 504, the apparatus monitors relative movement between the display and the light source. The monitoring and movement are similar as described with reference to FIGS. 2A-2J.

At block 505, the apparatus determines, at least one of position or orientation, of a light source in relation to the display, similar as described with reference to FIGS. 2A-2J.

At block 507, the apparatus determines orientation of the display, similar as described with reference to FIGS. 2A-2J.

At block 508, the apparatus receives an image indicating, at least one of position or orientation, of viewer of the display in relation to the display, similar as described with reference to FIGS. 2A-2J. The image may be the same image as described with reference to block 503.

At block 509, the apparatus determines, at least one of position or orientation, of a viewer of the display in relation to the display, similar as described with reference to FIGS. 2A-2J.

At block 510, the apparatus determines that light reflected by a display obstructs view of, at least part of, the display, similar as described with reference to FIGS. 2A-2J. The determination may be based, at least in part on the determined position or orientation of the light source, the determined position or orientation of the display, the determination of the position or orientation of the viewer, and/or the like.

At block 511, the apparatus causes ceasing of compensation for reflected light, similar as described with reference to FIGS. 1A-1F and FIGS. 2A-2J.

At block 512, the apparatus causes compensation for reflected light based, at least in part, on the determination that light reflected by a display obstructs view of, at least part of, the display, similar as described with reference to block 402 of FIG. 4.

FIG. 6 is a block diagram showing an apparatus, such as an electronic device 10, according to an example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention. Moreover, the apparatus of an example embodiment need not be the entire electronic device, but may be a component or group of components of the electronic device in other example embodiments.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna, (or multiple antennae), a wired connector, and/or the like in operable communication with a transmitter 14 and a receiver 16. The electronic device 10 may further comprise a processor 20 or other processing circuitry that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with wireline protocols, such as Ethernet, digital subscriber line (DSL), asynchronous transfer mode (ATM), second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry, for implementing audio, video, communication, navigation, logic functions, and/or the like, as well as for implementing embodiments of the invention including, for example, one or more of the functions described in conjunction with FIGS. 1A-6. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1A-6. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 1A-6. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. Display 28 may display two-dimensional information, three-dimensional information and/or the like.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1A-6. For example, the memories may comprise an identifier, such as an international mobile equipment identification (IMEI) code, which may uniquely identify the electronic device 10.

Electronic device 10 may comprise one or more sensor 37. Sensor 37 may comprise a light sensor, a proximity sensor, a motion sensor, a location sensor, and/or the like. For example, sensor 37 may comprise one or more light sensors at various locations on the device. In such an example, sensor 37 may provide sensor information indicating an amount of light perceived by one or more light sensors. Such light sensors may comprise a photovoltaic element, a photoreceptive element, a charge coupled device (CCD), and/or the like. In another example, sensor 37 may comprise one or more proximity sensors at various locations on the device. In such an example, sensor 37 may provide sensor information indicating proximity of an object, a user, a part of a user, and/or the like, to the one or more proximity sensors. Such proximity sensors may comprise capacitive measurement, sonar measurement, radar measurement, and/or the like.

Although FIG. 6 illustrates an example of an electronic device that may utilize embodiments of the invention including those described and depicted, for example, in FIGS. 1A-6, electronic device 10 of FIG. 6 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 6. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 502 of FIG. 5 may be performed after block 507. Furthermore, if desired, one or more of the above-described functions may be optional or may be combined. For example, blocks 502, 503, 504, 505, 507, 508, and 509 of FIG. 5 may be optional and/or combined with block 510.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. An apparatus, comprising:
a processor;
memory including computer program code, the memory and the computer program code configured to, working with the processor, cause the apparatus to perform at least the following:
determining that light reflected by a display obstructs view of, at least part of, the display; and
causing compensation for reflected light based, at least in part, on the determination that light reflected by a display obstructs view of, at least part of, the display.

2. The apparatus of claim 1, wherein compensation for reflected light comprises varying at least one reflective property of the display.

3. The apparatus of claim 2, wherein varying the reflective property comprises varying polarity of at least part of the display.

4. The apparatus of claim 2, wherein varying the reflective property comprises varying texture of at least part of the display.

5. The apparatus of claim 1, wherein compensation for reflected light comprises compensating information that is caused to be displayed on the display.

6. The apparatus of claim 5, wherein compensating information comprises utilizing a predetermined compensated set of information and causing display of at least part of the predetermined compensated set of information on the display.

7. The apparatus of claim 5, wherein compensating information comprises causing compensation generation of the information that is caused to be displayed.

8. The apparatus of claim 1, wherein the memory and the computer program code are further configured to, working with the processor, cause the apparatus to perform, at least, determining that light reflected by a display does not obstruct view of, at least part of, the display, and causing ceasing of compensation for reflected light based, at least in part, on the determined non-obstruction.

9. The apparatus of claim 1, wherein the memory and the computer program code are further configured to, working with the processor, cause the apparatus to perform, at least, determining, at least one of position or orientation, of a light source in relation to the display, wherein determining that light reflected by a display obstructs view of, at least part of, the display is based, at least in part, on the determined, at least one of position or orientation, of the light source.

10. The apparatus of claim 9, wherein the memory and the computer program code are further configured to, working with the processor, cause the apparatus to perform, at least, determining, at least one of position or orientation, of the display and determining, at least one of position or orientation, of the light source, wherein, at least one of position or orientation, of the light source in relation to the display is determined based, at least in part, on the, at least one of position or orientation, of the light source and, at least one of position or orientation, of the display.

11. The apparatus of claim 10, wherein determining, at least one of position or orientation, of the light source comprises retrieving information indicating, at least one of position or orientation, of the light source.

12. The apparatus of claim 9, wherein the memory and the computer program code are further configured to, working with the processor, cause the apparatus to perform, at least, receiving an image indicating the light source, wherein determining, at least one of position or orientation, of the light source in relation to the display is based, at least in part, on the image of the light source.

13. The apparatus of claim 12, wherein determining, at least one of position or orientation, of the light source in relation to the display is based, at least in part, on, at least one of position or orientation, of a camera that captured the image.

14. The apparatus of claim 9, wherein the memory and the computer program code are further configured to, working with the processor, cause the apparatus to perform, at least, monitoring relative movement between the display and the light source, wherein determining, at least one of position or orientation, of the light source in relation to the display is based, at least in part, on the movement and a previously determined, at least one of position or orientation, of the light source in relation to the display.

15. The apparatus of claim 1, wherein the memory and the computer program code are further configured to, working with the processor, cause the apparatus to perform, at least, determining orientation of the display, wherein determining that light reflected by a display obstructs view of, at least part of, the display is based, at least in part, on the orientation of the display.

16. The apparatus of claim 1, wherein the memory and the computer program code are further configured to, working with the processor, cause the apparatus to perform, at least, determining, at least one of position or orientation, of a viewer of the display in relation to the display.

17. The apparatus of claim 16, wherein the memory and the computer program code are further configured to, working with the processor, cause the apparatus to perform, at least, receiving an image indicating, at least one of position or orientation, of viewer of the display in relation to the display, wherein determining, at least one of position or orientation, of the viewer of the display in relation to the display is based, at least in part, on the image.

18. The apparatus of claim 16, wherein the viewer is a person.

19. The apparatus of claim 18, wherein determination of, at least one of position or orientation, of the person in relation to the display is based, at least in part, on face tracking.

20. The apparatus of claim 1, wherein determining that light reflected by a display obstructs view of, at least part of, the display is performed in response to determination that a lighting condition is conducive to light reflected by the display obstructing, at least part of, view of the display.

21. The apparatus of claim 1, further comprising the display.

22. An apparatus comprising:
means for determining that light reflected by a display obstructs view of, at least part of, the display; and
means for causing compensation for reflected light based, at least in part, on the obstruction determination.

23. A method comprising:
determining that light reflected by a display obstructs view of, at least part of, the display; and
causing compensation for reflected light based, at least in part, on the determination that light reflected by a display obstructs view of, at least part of, the display.

24. A computer-readable medium encoded with instructions that, when executed by a computer, perform:
determining that light reflected by a display obstructs view of, at least part of, the display; and
causing compensation for reflected light based, at least in part, on the determination that light reflected by a display obstructs view of, at least part of, the display.
